(19) United States
(12) Patent Application Publication
(10) Pub. No.: US 2010/0306055 A1
(43) Pub. Date: Dec. 2, 2010

(54) COMPELLED USER INTERACTION WITH ADVERTISEMENT WITH DYNAMICALLY GENERATED CHALLENGE

(75) Inventor: Mark Kolb, Aurora (CA)

Correspondence Address: ESCHWEILER & ASSOCIATES, LLC;NATIONAL CITY BANK BUILDING, 629 EUCLID AVE., SUITE 1000, CLEVELAND, OH, 44114, US

(73) Assignee: Knowledge Probe, Inc., Aurora (CA)

(21) Appl. No.: 12/472,047

(22) Filed: May 26, 2009

(51) Int. Cl. G06Q 30/00; G06Q 50/00

(52) U.S. Cl. 705/14.55

(57) ABSTRACT

Software applications may include many types of sponsorship-related features, such as integrated advertisements displayed to users and captchas that improve advertisement targeting by distinguishing human users vs. automated processes. However, these techniques may consume developers' efforts and creativity, and, if not well-integrated in the application, may annoy or distract users. As an alternative technique, an advertisement may be programmatically analyzed to generate a challenge and a solution. The challenge and an input component may be integrated into the application; a user's challenge response may be automatically compared with the solution; and a reward may be presented for satisfactory input. This automated technique may better integrate advertisements with the application and may improve the effectiveness of the advertising, while also reducing the amount of developer effort and creativity expended on the advertisement integration.

### BACKGROUND

In the field of software, some applications have been developed with aspects that facilitate the sponsorship of the application. As a first example, a developer may display an advertisement in an application, and may receive advertising funds from the advertiser that offset the costs of developing the application or providing the application to users. As a second example, a developer may endeavor to limit the use of an application or resource to human visitors, and to prevent or reduce the use of the application or resource by automated processes that simulate the behavior of a human visitor, by implementing a “captcha” feature. A captcha may comprise, e.g., one or more words generated against a background, where such words may be easily identified by a human but may be difficult to identify through an automated process. A developer may present such an image within an application, and may ask the user to input the words visible in the image, in order to verify that the visitor is a human. This mechanism may promote an advertising effort, such as by promoting the effectiveness of a presented advertisement by raising the incidence of presentation to human visitors. The advertising may therefore provide more revenue that may be used to promote the development or provision of the application to users.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While efforts have been made to relate an advertisement to an application, some such techniques may be deficient in one or more aspects. As a first example, if the advertisement is simply displayed in relation to an application (e.g., displayed before, concurrently but outside of, concurrently and within, or after the application), the user may not be inclined to accept or review the advertisement, which may be regarded as a nuisance or an unrelated distraction. As a second example, when a developer endeavors to integrate the advertisement with the application, this tying may involve a per-advertisement and per-application development cost that may divert resources (such as developers' efforts and creativity) from other tasks. Similarly, captchas may be regarded as an unrelated nuisance in the processing of the application; and while captchas might be automatically developed (e.g., by an algorithm that chooses words from a dictionary and embeds them in a difficult-to-analyze background), captcha are typically designed and intended to differentiate human visitors from automated processes, and are not easily reconfigured to relate to an advertisement.

Presented herein is an advantageous technique for relating an advertisement to an application. This technique involves programmatically generating a challenge and a solution based on information in the advertisement; presenting to the user within the application the challenge and an input component configured to accept input from the user; upon receiving from the user within the input component a challenge response, comparing the challenge response to the solution; and upon equating the challenge response and the solution, presenting a reward within the application. As a first example, an advertisement comprising an image may be automatically evaluated for a visual aspect (e.g., color schemes, object or face detection, or the relative positions of particular aspects of the image.) Based on this evaluation, a challenge may be automatically generated (e.g., “which words best describe the colors of this image?”; “how many faces are shown here?”; or “where is the red object in relation to the blue object?”), and the application may query the user for a response and compare it with the solution (comprising the output of the evaluation.) While endeavoring to determine the correct response, the user may be persuaded to examine the advertisement, thereby magnifying the impression of the displayed advertisement on the user. As a second example, a text-based advertisement may relate factual information, and the programmatically generated challenge and solution may correspond to a factual aspect of the advertisement (e.g., “what is the highway mileage of this automobile?”, or “what adjective might describe this product?”, relating to an adjective indicated in the advertisement.) The presentation may be more tightly integrated, e.g., by incorporating the challenge in an aspect of the application (such as a game that asks a question about a product in an advertisement rendered next to or within the application.) When the user provides the correct challenge response, the application may provide a reward, such as commencing execution, providing a resource requested by the user, or permitting the user to participate in an online service, such as a web forum.

This technique may offer advantages over other sponsorship-related techniques. As a first example, the automated generation of the challenge and solution (that is compared with the challenge response received from the user) may automatically establish a relationship between the application and a new advertisement without the involvement of a developer. As a second example, the automated generation may yield a much larger set of challenges and solutions relating the advertisement to the application than might be devised by a developer. As a third example, the nature of the challenge may be designed to compel users to examine the advertisement closely, in contrast with techniques (such as typical captchas) that direct the user's attention to an automatically generated image with little or no advertising value. For example, by generating a correct challenge response, the user may examine the advertisement in detail in a way that promotes understanding and recall. As a fourth example, the manner of integrating the challenge with the application may be selected to promote user acceptance of the challenge, thereby reducing user perception of the advertisement as a nuisance or distraction that may reduce its effectiveness.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary advertisement.

FIG. 2 is an illustration of a challenge and response that may be automatically generated from the exemplary advertisement of FIG. 1.

FIG. 3 is an illustration of another challenge and response that may be automatically generated from the exemplary advertisement of FIG. 1.

FIG. 4 is a flow chart illustrating an exemplary method of associating an advertisement with an application.

FIG. 5 is a component block diagram illustrating a scenario featuring an exemplary system for associating advertisements with applications.

FIG. 6 is an illustration of an exemplary computer-readable medium comprising processor-executable instructions configured to embody one or more of the provisions set forth herein.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

In the field of computing, the development and provision of software applications and other services often entails various costs in the development and provision of the application (e.g., the costs of hosting and executing a web application and of providing bandwidth to communicate with users over a network.) In order to cover these costs and/or to provide an incoming revenue stream, such applications sometimes incorporate various features relating to sponsorship of the application by advertisers. As a first example, the application may simply present an advertisement to the user, and the advertiser may pay the developer in proportion to the presentation of the advertisement (e.g., based on the number of users, the number of times the advertisement is displayed, or a share of sales of the advertised product resulting from the displayed advertisement.) As a second example, an advertisement may be displayed in the vicinity of the application, such as an advertisement embedded on a web page hosting a browser-based application. However, users who regard the advertisement as a nuisance may attempt to circumvent the viewing of the advertisement by using an automated process to simulate a human reception of the advertisement. Because such tactics may reduce the effectiveness of the advertisement and the compensation paid by the advertiser, the application developer may implement a “captcha”-based feature that distinguishes human visitors from automated processes. For example, the application may request a user to view an image with a randomly chosen word displayed against a noisy and busy background, and to input the displayed word in a text control. Because automated processes (such as optical character recognition) may exhibit a much lower capability to identify such words due to the difficult-to-parse background, respondents that correctly identify the word in the “captcha” image are more likely to be to be human visitors than automated processes, and the application developer may generate more revenue from the displayed advertisements than non-captcha-based techniques.

While many such techniques may be devised, some disadvantages may be involved in some techniques. As a first example, implementing an application that simply displays the advertisement (especially as an interruption of the application, or in the vicinity of the application in a way that visually or functionally distracts the user) may cause users to view the advertisement as a nuisance or distraction, especially if the advertisement is not thematically, aesthetically, or functionally related to the application. Conversely, the developer may endeavor to make the advertisement less visible or distracting (e.g., by reducing the size of an image), but this may reduce the effectiveness of the advertisement. As a second example, a developer may attempt to integrate an advertisement in the application, such as by functionally or semantically linking some aspects of the advertisement to the application, but this technique may consume some effort and creativity of the developer. Moreover, such efforts are likely applicable only to the particular advertisement(s) so integrated by the developer, and integrating new advertisements in the application may involve additional developer effort and creativity. As a third example, a captcha-based feature that distinguishes human visitors from automated processes may result in more advertisements being served to humans, but might not promote the impression of the advertisement on the user or the interaction of the user with the advertisement.

An alternative technique may be devised to create a relationship between an application and an advertisement. This technique may involve programmatically analyzing the advertisement to generate a challenge and a solution relating to the advertisement. The challenge may then be presented to the user within the application, along with an input component where the user may respond to the challenge. The technique may then involve receiving the challenge response provided by the user and comparing the challenge response with the solution. If the challenge response is determined to equate to the solution (either exactly or within a degree of tolerance, e.g., with minor variations in spelling, punctuation, or capitalization between a textual solution and a textual challenge response), the application may present a reward to the user. The integration of the advertisement with the application (both by generating an interactive challenge that the user may enjoy, and that may thematically fit with the application, and by providing the reward within the application) may promote the appeal and reduce the nuisance of the advertisement perceived by the user, thereby improving the effectiveness of the advertisement. Moreover, by performing this technique programmatically (e.g., by automatically analyzing the advertisement, generating the challenge and solution and embedding them in the application, comparing the challenge response to the solution, and presenting the reward), the technique may be applied to incorporate many advertisements in many applications with little or no developer interaction, even for new advertisements and applications.

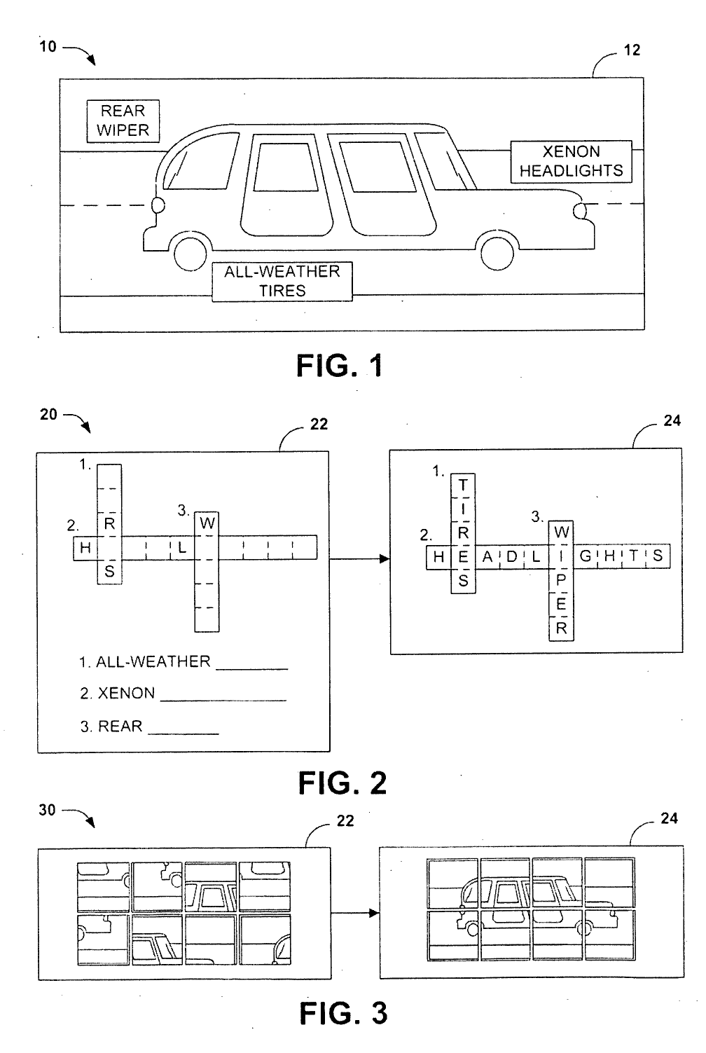

FIG. 1 presents an exemplary scenario 10 featuring an advertisement 12 designed as a picture that relates factual information about the product. In this exemplary scenario 10, the advertisement depicts an automobile having various features, such as a rear-window wiper, all-weather tires, and xenon headlights. The advertisement 12 might be programmatically evaluated in many ways to generate a challenge and solution that may be incorporated in an application. FIG. 2 illustrates a first example 20 of a challenge 22 and solution 24 in the form of a crossword puzzle that may be programmatically generated from the advertisement 12 of FIG. 1. The factual information in the advertisement 12 may be programmatically extracted and assembled into a puzzle that a user may solve (by filling in letters to produce a challenge response) in order to receive a reward. The programmatic analysis may therefore yield a challenge 22 comprising an incomplete crossword puzzle based on the facts illustrated in the advertisement 12 and a solution 24 comprising the completed crossword puzzle. The challenge 22 may then be presented within an application, and the user may be permitted to interact with the puzzle (as an input component) to produce a challenge response. As a second example, FIG. 3 illustrates a second example 30 of a challenge 22 and solution 24 in the form of a jigsaw puzzle that may be programmatically generated from the advertisement 12 of FIG. 1. In this second example 30, the picture comprising the advertisement 12 may be segmented to form sliding tiles, which, when randomly mixed and presented, comprise the challenge 22. The solution 24 comprises an arrangement of the sliding tiles matching the advertisement 12, and the user may be permitted to assemble a challenge response by sliding tiles in order to achieve the solution. Other types of challenges and solutions may also be programmatically derived from the advertisement 12, such as a simple question-and-answer pair (“what type of tires?”) or a visual analysis (“which of these pictures is correctly colored to match the advertisement?”)

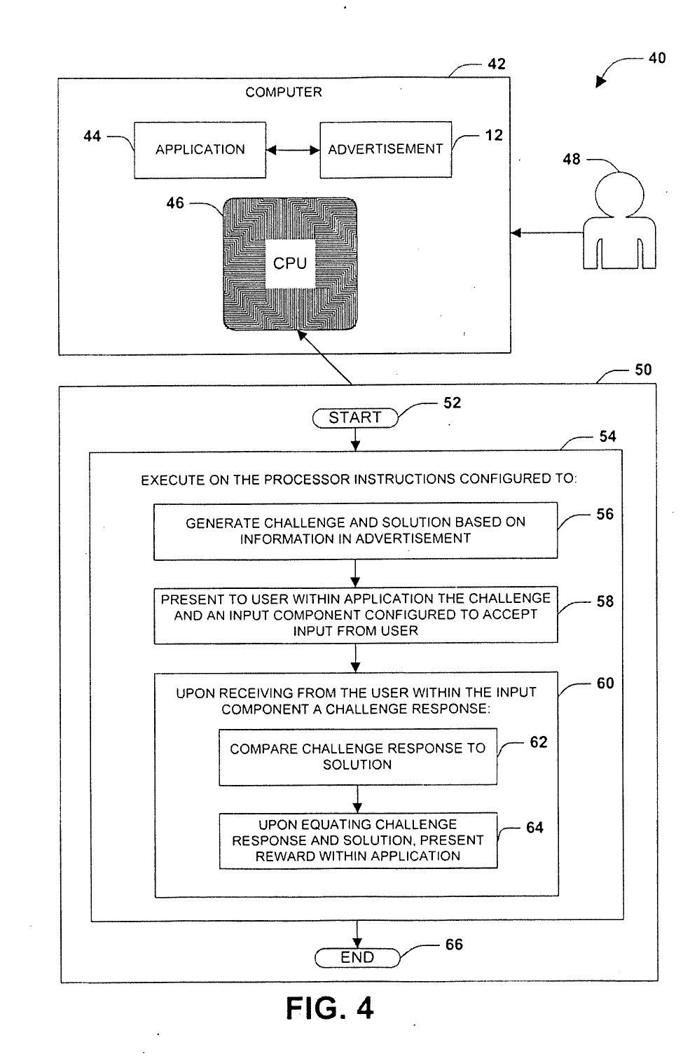

This technique may be utilized in many embodiments. FIG. 4 presents a scenario 40 featuring a first exemplary embodiment of this technique, comprising a method 50 of relating an advertisement 12 to an application 44 presented to a user 48 of a computer 42 having a processor 46. As discussed herein, the user 48 may physically interact with the computer 42, such as through one or more input devices (e.g., a keyboard or mouse) attached to the computer 42; or may interact with the computer 42 at a distance; e.g., the computer 42 may comprise a server that communicates over a network with a second computer operated by the user 48; etc. Within this scenario 40, a method 50 may be utilized that begins at 52 and involves executing 54 a set of instructions on the processor 46 of the computer 42 that implement the techniques discussed herein. These instructions may be configured to generate 56 a challenge 22 and a solution 24 based on information in the advertisement 12. The challenge 22 and the solution 24 may take many forms, such as a factual or visual puzzle or a question-and-answer pair, and may be generated by many forms of programmatic analysis that may be applied to the advertisement 12, e.g., image analysis, natural-language parsing, or letter-matching algorithms. The instructions of the method 50 are also configured to present 58 the challenge 22 to the user 48 within the application 44, as well as an input component configured to accept input from the user 48 (e.g., a textbox configured to receive textual input; a voice-recognition component configured to receive voice input; or an interactive interface that allows a user to operate a puzzle, such as by entering letters in the crossword puzzle of FIG. 2, such as by typing letters in with a keyboard, or dragging-and-dropping letters onto the puzzle, or by sliding tiles in the sliding-tile puzzle of FIG. 3.) The instructions of the method 50 are also configured to, upon receiving 60 from the user 48 within the input component a challenge response, compare the challenge response to the solution 24, and to, upon equating the challenge response and the solution 24, present a reward within the application 44 to the user 48. For example, if the user 48 enters a sufficient number of correct letters into the crossword puzzle of FIG. 2, the application 44 may display a pleasant animation, may present a game that the user 48 may wish to play, or may perform a task that the user 48 wishes the computer 42 to perform. In this manner, the exemplary method 50 thereby relates the advertisement 12 to the application 44, and so ends at 66.

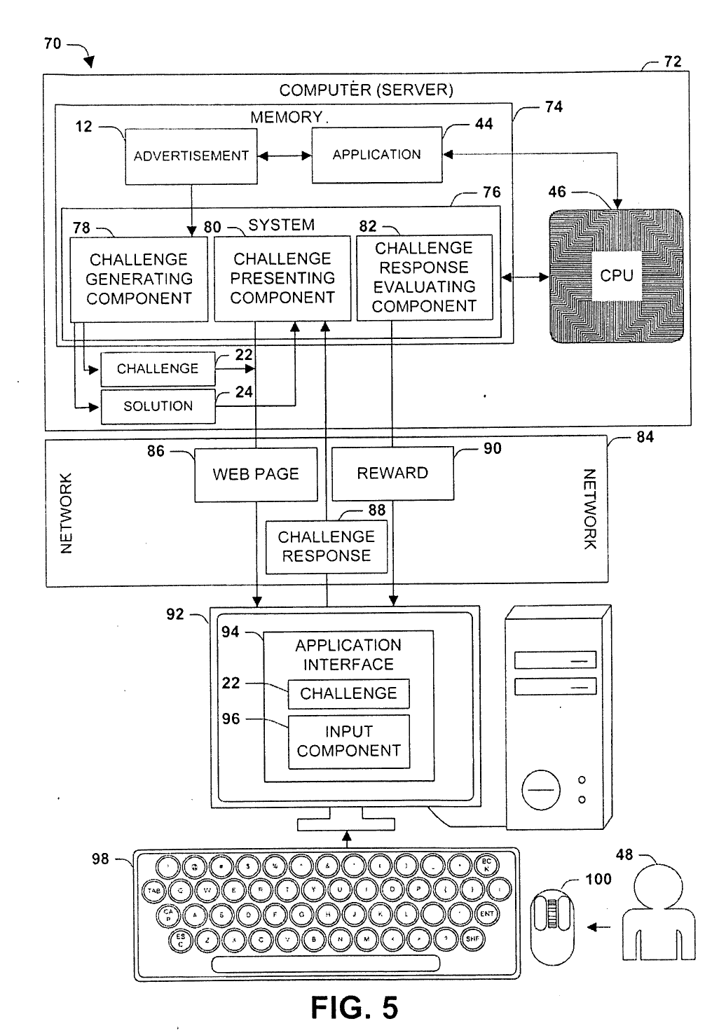

FIG. 5 presents another scenario 70 featuring another embodiment of the techniques discussed herein. In this scenario 70, an advertisement 12 is to be related to an application 44 that is presented to a user 48 of a computer 72 having a processor 46. In this scenario 70, the computer 72 is a webserver configured to host the application 44 and to execute the application 44 upon request by the user 48, such as a server-side web application. The server may therefore be configured to communicate with a client computer 92 operated by the user 48 over a network 84. More specifically, the server may comprise a webserver that, upon receiving a request from the user 48, executes the application 44 as a server-side web application, and sends to the client computer 92 an application interface 94 embedded within a web page 86. The client computer 92 may therefore render the application interface 94 (e.g., within a web browser), and may communicate with the user 48 through one or more input devices, such as a keyboard 98 or mouse 100. Thus, while the user 48 may not be in the physical proximity of the computer 72, the user 48 nevertheless interacts with the computer 72 and the application 44 executed thereupon, and an administrator of the computer 72 may defray the expenses associated with storing, communicating, and executing the application 44 on the computer 72 by relating the application 44 to one or more advertisements 12. When the user 48 views the advertisement 12, the advertiser may pay the administrator of the computer 72 for the placement of the advertisement 12 to the user 48, and such payment may present a revenue stream and/or offset the costs of hosting the application 44.

Within this scenario 70, the techniques may be implemented as an exemplary embodiment comprising a system 76 configured to relate the advertisement 12 to the application 44. The system 76 may include a challenge generating component 78, which may be configured to generate a challenge 22 and a solution 24 based on information in the advertisement 12. The system 76 may also comprise a challenge presenting component 80, which may be configured to present the challenge 22 to the user 48 within the application 44, as well as an input component 96 configured to accept input from the user 48. For example, the challenge presenting component 80 may deliver a web page 86 over the network 84 to the client computer 92, which may then render the web page 86, including an application interface 94 embedding the challenge 22 and the input component 96. The user 48 may then view and evaluate the challenge 22, and may attempt to solve the challenge 22 by submitting a challenge response 88 (e.g., a solution to a puzzle, a text entry in a textbox, a correct set of input controlling a game, etc.) The challenge response 88 may then be delivered by the client computer 92 to the computer 72. In order to handle the challenge response 88, the system 76 may comprise a challenge response evaluating component 82, which may be configured to receive the challenge response 88 within the input component 96 generated by the user 48 and to compare the challenge response 88 to the to the solution 24. If the challenge response evaluating component 82 equates the challenge response 88 with the solution 24, the challenge response evaluating component 82 may then present a reward within the application 44 (e.g., within the application interface 94 presented to the user 48 by the client computer 92.) By operating in this manner within this scenario 70, the system 76 may thereby relate the advertisement 12 to the application 44 in a comparatively integrated manner and may persuade the user 48 to interact with the advertisement 12 (as an improvement over merely displaying the advertisement 12 to the user 48), while doing so in an automated manner that does not involve a developer's efforts or creativity in designing and specifying the relationship between the advertisement 12 and the application 44.

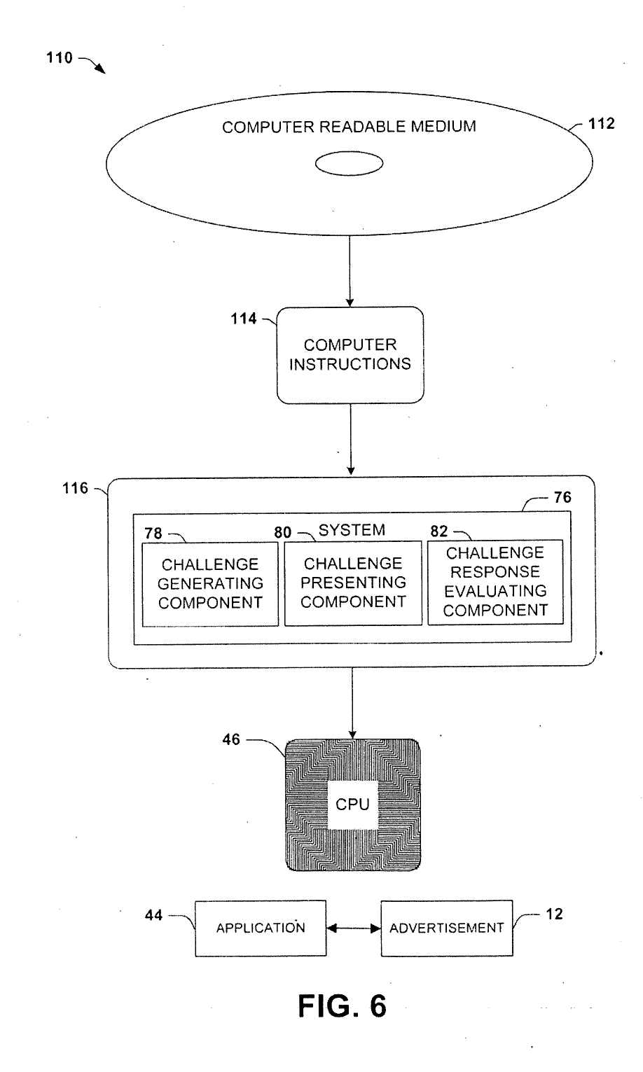

FIG. 6 illustrates a scenario 110 featuring still another embodiment of these techniques, involving a computer-readable medium 112 encoding processor-executable instructions 114 that are configured to apply the techniques presented herein. The computer-readable medium 112 may comprise, e.g., a CD-R, DVD-R, or a platter of a hard disk drive, on which is encoded computer-readable binary data. This computer-readable binary data encodes a set of computer instructions 114 that, when executed by a processor 46 of a computer, are configured to operate according to the principles set forth herein. In one such embodiment (as depicted in FIG. 6), the processor-executable instructions may be configured to implement a system for relating an advertisement to an application presented to a user, such as the exemplary system 76 of FIG. 5. In another such embodiment (not shown), the processor-executable instructions may be configured to perform a method of relating an advertisement to an application presented to a user, such as the exemplary method 50 of FIG. 4. Many such computer-readable media, and many other forms of embodiments, may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 50 of FIG. 4 and the exemplary system 76 of FIG. 5) to confer individual and/or synergistic advantages upon such embodiments.

A first aspect that may vary among embodiments of these techniques relates to the architecture of the embodiment and/or the computer configured to execute the embodiment. As contrastingly illustrated in FIGS. 4 and 5, the computer 42 executing an embodiment of these techniques may be physically accessible to the user 48, or may comprise a server accessed by the user operating a client computer may communicate with a client computer operated by the user 48 over a network 84 (such as the internet.) In one such embodiment, the application 44 may execute natively on the computer that is also executing the techniques discussed herein. In another such embodiment, the application 44 may comprise a natively executing application that is wholly deployed by the computer to the client computer accessible to the user 48. In yet another such embodiment, the application 44 may comprise a web application, which may be executed within a web browser executing on the client computer as requested by the user 48. The computer may therefore comprise a webserver, which may be configured to receive the request from the user 48 over the network 84, and may send to the client computer over the network 84 the challenge 22 and the input component 96 (e.g., as components embedded in a web page 86), which may be presented to the user 48 within the application 44 on the client computer. Moreover, the application 44 may execute as a client-side application, such as wholly executing on the client computer of the user 48, or as a server-side application on the webserver, which may send to the client computer only an application interface 94 that presents the output of the application 44 to the user 48 and accepts input to be relayed to the application 44 executing on the webserver. Other architectures may also be compatible with the techniques discussed herein (e.g., a shared application that executes partially on the webserver and partially on the client computer.) As another architectural variation, the elements of an embodiment (such as the exemplary system 76 of FIG. 5) may vary in number, capabilities, and interconnectedness.

Other architectural variations may relate to the types of computer comprising the embodiment and/or used by a user to access the application (e.g., a workstation, a notebook, a distributed computing process over a set of machines, or a mobile device.) As a first example, the computer may access the advertisement from another website that hosts the advertisement; or may receive the advertisement from an advertiser; or may natively host or generate the advertisement to be utilized by these techniques. As a second example, the computer may access a source of the advertisement and/or a client computer used by the user through many types of communications channels, such as the internet, a local area network, or a cellular network. As a third example, the advertisement and/or the application may comprise many forms of data, such as a marked-up document (e.g., HTML or XML) that may be interpreted and/or rendered for the user; an image or other multimedia object; a printable document such as a PDF document; an interactive application, such as a Java, Flash, ASP.NET, or Silverlight application executed for the user; one or more records in a database, etc. Those of ordinary skill in the art may select one of many suitable architectures while implementing the techniques discussed herein.

A second aspect that may vary among embodiments of these techniques relates to the types of applications 44 to which the techniques are applied, and the types of challenges 22 and input components 96 embedded and utilized thereby. As a first example, the application 44 may comprise a game, such as a crossword puzzle, a sliding tile puzzle, a Sudoko or similar mathematical puzzle, a factual trivia game, an arcade game, etc. As a second example, the application 44 may comprise a tool or service that is capable of performing a task requested by the user. As a third example, the application 44 may comprise a media renderer that may be capable of rendering a media item (e.g., a picture, video or audio segment, an interactive model, or a document) that the reader requests to have rendered. As a fourth example, the application 44 may comprise an online service that is provided by a server, such as a file or resource server that stores a file or resource requested by the user, or an online forum in which the user wishes to participate. In each of these and other types of applications, a range of suitable types of challenges 22 and input components 96 may be selected and incorporated. In a first such set of embodiments, a media segment may incorporate some information that is programmatically extracted from the advertisement, and at a certain point in the media segment, the user may be presented with a challenge asking about the advertisement information and allowing the user to continue viewing the media segment only if a correct answer is provided in a speech or text input component. In a second such set of embodiments, an interactive model (such as a simulated three-dimensional environment) may present the challenge as a three-dimensional object that the user may manipulate to find the solution; as an goal within the simulated environment that may be achieved only using the information presented in the advertisement; or as an avatar that blocks access to a particular portion of the simulated environment unless the user correctly answers questions about the advertisement (where such questions and answers are automatically extracted from the advertisement.)

A third aspect that may vary among embodiments of these techniques relates to the manner of generating the challenge and the solution form the advertisement. In addition to the many types of applications to which these techniques may be applied (e.g., games, utilities, resource managers, online services, and simulated environments) and the manner of integrating the challenge with the application (e.g., as a crossword puzzle, as a sliding tile puzzle, in a question-and-answer format), many automated processes may be utilized to derive the information comprising the challenge and the solution from the advertisement. A first set of examples relate to a visual advertisement, such as a picture or a video segment. For such advertisements, the techniques discussed herein may be applied by programmatically analyzing the image to identify a visual aspect, generating the challenge as a query relating to the visual aspect, and generating the solution as a description of the visual aspect. Many types of image analysis may be utilized to generate a challenge and a solution therefrom that may be integrated into the application. A first example relates to an automated segmentation of the advertisement, wherein the challenge involves displaying the segments in an incorrect order, the solution involves the correct ordering of the segments, and the user is permitted to manipulate the segments (e.g., moving, swapping, rotating, scaling, or flipping the segments, or ordering a set of video segments along a chronological axis) to produce a challenge response. These challenges and responses may be integrated, e.g., as in the sliding tile puzzle presented in FIG. 3, or as a jigsaw puzzle, as a scavenger hunt, etc. A second example involving a visual advertisement involves image analysis algorithms, such as face detection, shape detection, color or spectrum analysis, or edge analysis. A challenge may be generated from an advertisement by applying such techniques to produce an altered image (e.g., removing one or more shapes or colors from the image; extracting only an identified shape, face, or object from the image; or dividing the image along detected gradients or boundaries) and challenging the user to interact with the image, e.g., to derive the original image or to identify missing information. Similar types of analysis, extraction, and challenge/solution generation may apply to non-visual aesthetic aspects of the advertisement. For example, an audio portion of an advertisement may be extracted and altered (e.g., by changing the tempo or waveform of the audio, by adding background noise, or by adding digital artifacts such as through lossy compression), and the user may be permitted to adjust the audio and challenged to produce the original audio.

A second set of examples for automatically generating a challenge and solution involves factual analysis of an advertisement. For example, if an advertisement includes text describing a product, an automated algorithm might challenge the user to provide some of the facts illustrated in the advertisement. For such advertisements, the techniques discussed herein may be applied by programmatically analyzing the advertisement to identify a factual aspect, generating the challenge as a query soliciting the factual aspect, and generating the solution as the factual aspect. For example, a natural-language parsing algorithm might automatically identify pairs of words denoting a fact (e.g., an adjective/noun pair might comprise a fact or description.) Alternatively, the advertisement may contain a comparison of a product to a competitor's product (such as in tabular form) or one or more quantitative facts (e.g., “35 MPG highway”) that might form the basis of a challenge and solution. Moreover, from any particular identified fact, the algorithm may generate many types of challenges and responses (e.g., “how many MPG?”; “35 represents the number of: (a) MPG highway, (b) MPG city, (c) horsepower, (d) price”; “the MPG highway measure is: (a) 10-20; (b) 20-30; (c) 30-40 . . . ”) Of course, many types of techniques may be used to extract many types information from the advertisement in order to generate the challenge and the solution. Even completely arbitrary information may be extracted and used in the performance of these techniques (e.g., letters, numbers, colors, or shapes may be automatically identified and used in various forms of challenges and responses, such as an automatically generated Sudoku puzzle that utilizes numeric clues corresponding to digits that are automatically identified in and extracted from the advertisement.)

A third set of examples involve a “mechanical Turk” model of generating a challenge and solution. For example, some users may be asked to identify a challenge/solution pair relating to an advertisement (such as a question that is answerable by examining the advertisement.) A user's proposed challenge and solution may be tested on users, and if a significant number of users answer correctly based on the advertisement, the challenge and solution may be more broadly adopted for general use. It may be appreciated that this technique is still heavily automated because, although user effort and creativity are involved, the generation, testing, and use of the challenge and the solution involve little or no effort by a developer of the application or advertisement. More generally, those of ordinary skill in the art may devise many techniques for automatically analyzing the advertisement and generating a challenge and solution while implementing the techniques discussed herein.

A fourth aspect that may vary among embodiments of these techniques relates to the manner in which the advertisement is related to the application. In particular, the nature of the relationship may entail a varying degree of user effort involved in addressing the challenge and producing a challenge response. In more conventional advertising techniques, the “challenge” may not be present—e.g., the advertisement may simply be displayed to the user for a particular length of time, and the user may not have to take any action or even glance at the advertisement. Similarly, in conventional captcha challenges, the advertisement may simply be displayed while or after the user solves the captcha challenge in order to verify that the user is a human visitor, and not an automated process; the user's efforts may be completely unrelated to the advertisement, and the user may completely disregard the advertisement. By contrast, in these techniques, the challenge involves a degree of user interaction with the advertisement in addressing the challenge and preparing the challenge response, because the relationship of the challenge to the solution is based on the information extracted from the advertisement. In one such embodiment, the advertisement may be presented within or near the application (e.g., displayed adjacent to a web application within the same web page.) The user may be able to provide an acceptable challenge response by examining the advertisement. In another such embodiment, the advertisement may be functionally interrelated with the application, such that the user may interact with the advertisement to produce the challenge response. For example, as in FIG. 3, the advertisement may be a picture that, according to the techniques discussed herein, is automatically divided into sliding tiles with which the user may interact in order to rearrange the tiles into the proper ordering. In a third such embodiment, the advertisement is accessible to the user, but may not presented to the user concurrently with the application. For example, the application or challenge may direct the user to visit the website of the advertiser to find information used to produce a suitable challenge response. Alternatively, the application may simply present the challenge without a suggestion of how the user may obtain the information, but the advertisement may be positioned within a location that the user may be likely to visit (e.g., as a highly ranked search result in a popular search engine.) This technique may be particularly advantageous by de-emphasizing the advertising aspect of the information; the user is challenged to conduct research of his or her own choosing, thereby presenting less perceived nuisance than with an advertisement that is simply presented to the user.

As an additional variation of this fourth aspect, the computer may comprise an advertisement store comprising at least two advertisements (respectively relating to one or more products and/or received from one or more advertisers.) The computer may select a particular advertisement from the advertisement store for a particular user and/or for a particular application, and may apply the techniques discussed herein for the selected advertisement. For example, the computer may generate the challenge and the solution by selecting an advertisement from the advertisement store and generating the challenge and the solution based on the selected advertisement. The computer may also present the selected advertisement concurrently with the application (e.g., by integrating the advertisement in the application, such as by segmenting the selected advertisement into tiles and presenting to the user a slidable tile puzzle, or by displaying the advertisement within or adjacent to the application.) Those of ordinary skilled in the art may devise many techniques of relating the advertisement to the application while implementing the techniques discussed herein.

A fifth aspect that may vary among embodiments of these techniques relates to the manner of comparing the challenge response with the solution, and of determining whether the challenge response equates to the solution. In one such embodiment, the challenge response may be determined to equate to the solution only if a complete match exists. This embodiment may be useful, e.g., for puzzles with only one clear and complete solution (e.g., the sliding puzzle of FIG. 3), or for questions for which only one answer is acceptable, such as a question eliciting a numeric answer. In other embodiments, the challenge response may be equated with the solution if the comparison falls within a degree of tolerance. For example, when comparing a textual solution with a textual challenge response, the comparison may disregard non-semantic aspects, such as capitalization, punctuation, and whitespace, and/or may attempt to disregard spelling variations (e.g., by computing a degree of similarity of a challenge response string with a solution string, and equating comparisons having 90% of matching characters.) Those of ordinary skill in the art may devise many ways of comparing and equating the challenge response and the solution while implementing the techniques discussed herein.

A sixth aspect that may vary among embodiments of these techniques relates to the types of rewards that may be presented to the user upon equating the challenge response with the solution. Just as these techniques may be applied to relate advertisements to many types of applications, these techniques may present users with many types of rewards, based on the type of application. As a first example, where the application comprises an application that the user wishes to execute, the challenge and input component may be presented to the user as a precondition of executing the application, and the reward may be presented by initiating the execution of the application for the user. As a second example, the challenge may be presented in an already-executing application (e.g., between levels of a game being played by the user, or before performing a task in a utility application); the application may be suspended before presenting the challenge, and the reward may be presented by resuming the application. As a third example, the application may comprise a service from which the user has requested a resource, such as a file server from which the user has requested a particular file, or a database against which the user has submitted a desired query to be executed. In this example, presenting the reward may comprise sending the requested resource to the user. As a fourth example, the computer may comprise a provider of an online service, and the user may have requested participation in the online service (e.g., registering a user account for a website, or posting an entry in an online forum); the application may present the challenge as a precondition of permitting the participation, and presenting the reward may comprise permitting the participation of the user in the online service. Those of ordinary skill in the art may devise many types of rewards and manners of reward presentation while implementing the techniques discussed herein.

A seventh aspect that may vary among embodiments of these techniques relates to additional features and components that may be added to various embodiments (such as the exemplary method 50 of FIG. 4 and the exemplary system 76 of FIG. 5.) In one such variation, provisions may be made in case the challenge response does not equate to the solution. In one such set of embodiments, the user may be permitted to try again by inputting a different challenge response, and may be given a particular (but finite) set of retries before a failure state is reached. For example, the application may define a challenge retry limit, and before presenting the challenge and the input component to the user, the computer may initialize a retry counter that is configured to track retries of the challenge by the user. Upon failing to equate the challenge response and the solution, the computer may increment the retry counter and compare the retry counter to the challenge retry limit. Upon determining the retry counter as not exceeding the challenge retry limit, the computer may again present the challenge and the input component to the user, who may submit a different challenge response to the computer through the input component. In some such embodiments, the computer may react if the retry counter is determined to exceed the challenge retry limit. For example, the computer may simply report a failure of the user to complete the challenge. Alternatively, the computer may generate a second challenge and a second solution based on information in the advertisement, and may present the second challenge and an input component to the user within the application. This alternative may be useful, e.g., for replacing an overly difficult challenge with a more easily solvable challenge, or for handling the circumstance where the first automatically generated challenge and response might be ambiguous or indeterminate.

In another variation of this seventh aspect, the computer may be configured to track challenge results, such as in a database of challenge results. This database may be useful, e.g., for assessing the quality of automatically generated challenges and solutions, and/or tweaking the challenge generating component to produce more desirable challenges and solutions. For example, the computer may be configured to record user responses to challenges comprising a successful user response, an unsuccessful user response, and an incomplete user response. Upon equating the challenge response and the solution, the computer may record a successful user response, and upon failing to equate the challenge response and the solution, the computer may record an unsuccessful user response. Incomplete attempts may be recorded, e.g., by initially recording an incomplete user response when the challenge is generated for the user, and by replacing the incomplete user response record with a successful or unsuccessful user response record after the comparing, or by recording the incomplete user response upon detecting a timeout event.

In still another variation of this seventh aspect, the application may supplement the advertisement and/or the challenge with additional features. As a first example, the application may also incorporate a captcha-like mechanism that distinguishes human visitors from automated processes (either as part of the challenge or as a separate feature of the application.) As a second example, the application may permit the user to interact with the advertisement, such as by allowing the user to request and receive additional information about the advertised product, by allowing the user to explore customizable options of the advertised product, and/or by allowing the user to purchase the advertised product. Those of ordinary skill in the art may devise many additional features that may be incorporated into embodiments of the techniques discussed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

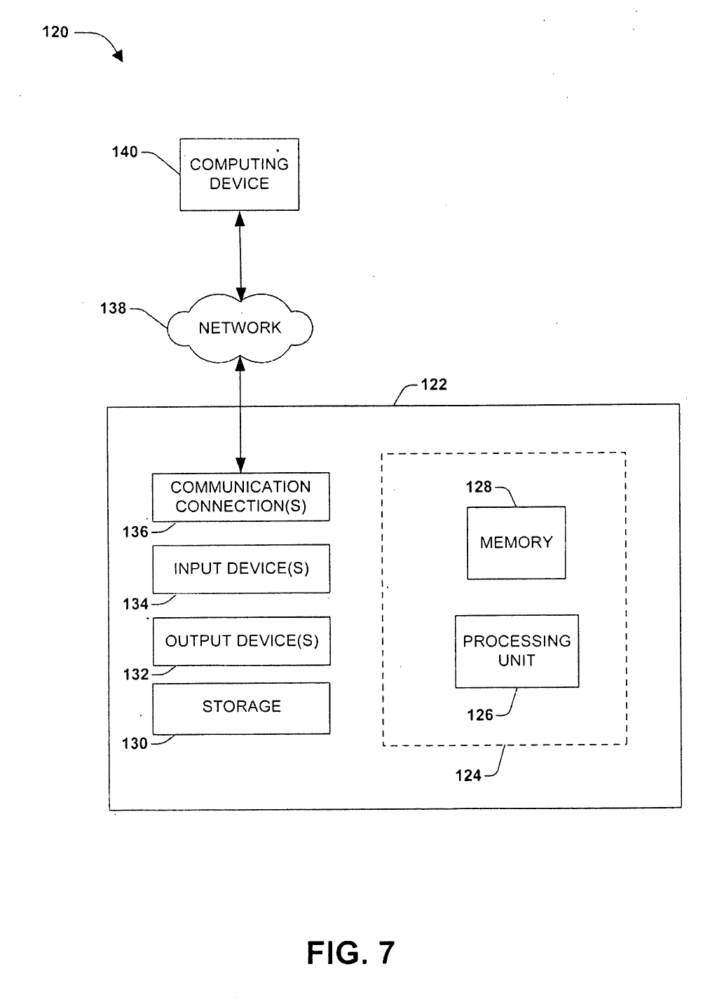

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 120 comprising a computing device 122 configured to implement one or more embodiments provided herein. In one configuration, computing device 122 includes at least one processing unit 126 and memory 128. Depending on the exact configuration and type of computing device, memory 128 may be volatile (such as RAM, for example), non-volatile (such as ROM, flash memory, etc., for example) or some combination of the two. This configuration is illustrated in FIG. 7 by dashed line 124.

In other embodiments, device 122 may include additional features and/or functionality. For example, device 122 may also include additional storage (e.g., removable and/or non-removable) including, but not limited to, magnetic storage, optical storage, and the like. Such additional storage is illustrated in FIG. 7 by storage 130. In one embodiment, computer readable instructions to implement one or more embodiments provided herein may be in storage 130. Storage 130 may also store other computer readable instructions to implement an operating system, an application program, and the like. Computer readable instructions may be loaded in memory 128 for execution by processing unit 126, for example.

The term “computer readable media” as used herein includes computer storage media. Computer storage media includes volatile and nonvolatile, removable and non-removable media implemented in any method or technology for storage of information such as computer readable instructions or other data. Memory 128 and storage 130 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 122. Any such computer storage media may be part of device 122.

Device 122 may also include communication connection(s) 136 that allows device 122 to communicate with other devices. Communication connection(s) 136 may include, but is not limited to, a modem, a Network Interface Card (NIC), an integrated network interface, a radio frequency transmitter/receiver, an infrared port, a USB connection, or other interfaces for connecting computing device 122 to other computing devices. Communication connection(s) 136 may include a wired connection or a wireless connection. Communication connection(s) 136 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 122 may include input device(s) 134 such as keyboard, mouse, pen, voice input device, touch input device, infrared cameras, video input devices, and/or any other input device. Output device(s) 132 such as one or more displays, speakers, printers, and/or any other output device may also be included in device 122. Input device(s) 134 and output device(s) 132 may be connected to device 122 via a wired connection, wireless connection, or any combination thereof. In one embodiment, an input device or an output device from another computing device may be used as input device(s) 134 or output device(s) 132 for computing device 122.

Components of computing device 122 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 122 may be interconnected by a network. For example, memory 128 may be comprised of multiple physical memory units located in different physical locations interconnected by a network.

Those skilled in the art will realize that storage devices utilized to store computer readable instructions may be distributed across a network. For example, a computing device 140 accessible via network 138 may store computer readable instructions to implement one or more embodiments provided herein. Computing device 122 may access computing device 140 and download a part or all of the computer readable instructions for execution. Alternatively, computing device 122 may download pieces of the computer readable instructions, as needed, or some instructions may be executed at computing device 122 and some at computing device 140.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of relating an advertisement to an application presented to a user of a computer having a processor, the method comprising:
executing on the processor instructions configured to:
generate a challenge and a solution based on information in the advertisement;
present to the user within the application the challenge and an input component configured to accept input from the user; and
upon receiving from the user within the input component a challenge response:
compare the challenge response to the solution, and
upon equating the challenge response and the solution, present a reward within the application.

2. The method of claim 1, the challenge and the solution relating to a visual aspect of the advertisement.

3. The method of claim 2:
the advertisement comprising at least one image, and
generating the challenge and solution comprising:
programmatically analyzing the image to identify a visual aspect of the at least one image;
generating the challenge as a query relating to the visual aspect of the at least one image; and
generating the solution as a description of the visual aspect of the at least one image responsive to the query.

4. The method of claim 1, the challenge and the solution relating to a factual aspect of the advertisement.

5. The method of claim 4, generating the challenge and solution comprising:
programmatically analyzing the advertisement to identify a factual aspect of the advertisement;
generating the challenge as a query soliciting the factual aspect of the advertisement; and
generating the solution as the factual aspect of the advertisement.

6. The method of claim 4, the advertisement accessible to the user and not presented to the user concurrently with the application.

7. The method of claim 1:
the application executed upon a request of the user;
presenting the challenge and the input component comprising: presenting to the user the challenge and an input component configured to accept input from the user as a precondition of executing the application for the user; and
presenting the reward comprising: executing the application for the user.

8. The method of claim 1:
the instructions configured to, before presenting the challenge and the solution, suspend the application; and
the reward comprising: resuming the application.

9. The method of claim 1:
the instructions configured to, before generating the challenge and the solution, receive from the user a request for a resource; and
presenting the reward comprising: sending the resource to the user.

10. The method of claim 1:
the application executed to enable participation by the user in an online service;
presenting the challenge and the input component comprising: presenting to the user the challenge and an input component configured to accept input from the user as a precondition of permitting the participation by the user in the online service; and
presenting the reward comprising: permitting the participation by the user in the online service.

11. The method of claim 1, the instructions configured to present the advertisement to the user concurrently with the application.

12. The method of claim 11:
the computer having access to an advertisement store comprising at least two advertisements;
generating the challenge and the solution comprising:
selecting an advertisement from the advertisement store, and
generating the challenge and the solution based on the selected advertisement; and
presenting the advertisement comprising: presenting the selected advertisement concurrently with the application.

13. The method of claim 11, presenting the advertisement comprising: integrating the advertisement with the application.

14. The method of claim 1:
the application defining a challenge retry limit, and
the instructions configured to:
before presenting the challenge and the input component to the user, initializing a retry counter configured to track retries of the challenge by the user; and
upon failing to equate to equate the challenge response and the solution:
incrementing the retry counter;
comparing the retry counter to the challenge retry limit; and
upon determining the retry counter as not exceeding the challenge retry limit, again presenting the challenge and the input component to the user.

15. The method of claim 14, the instructions configured to, upon determining the retry counter as exceeding the challenge retry limit:
generate a second challenge and a second solution based on information in the advertisement, and
present to the user within the application the second challenge and an input component configured to accept input from the user.

16. The method of claim 1:
the computer configured to record user responses to challenges comprising a successful user response, an unsuccessful user response, and an incomplete user response; and
the instructions comprising:
upon equating the challenge response and the solution, recording a successful user response; and
upon failing to equate the challenge response and the solution, recording an unsuccessful user response.

17. A system for relating an advertisement to an application presented to a user of a computer having a processor, the system comprising:
a challenge generating component configured to generate a challenge and a solution based on information in the advertisement;
a challenge presenting component configured to present to the user within the application the challenge and an input component configured to accept input from the user; and
a challenge response evaluating component configured to:
receive from the user within the input component a challenge response,
compare the challenge response to the solution, and
upon equating the challenge response and the solution, present a reward within the application.

18. The system of claim 17, the computer comprising a server accessed over a network by a client computer operated by the user.

19. The system of claim 18:
the application comprising a web application;
the client computer comprising a web browser executing the web application requested by the user; and
the server comprising a webserver configured to:
receive the request from the user over the network to execute the web application, and
send to the client computer over the network the challenge and the input component to be presented to the user on the client computer within the web application.

20. A computer-readable medium comprising instructions that, when executed on a processor of a computer, perform a method of relating an advertisement to an application presented to a user of the computer, the method comprising:
generating a challenge and a solution based on information in the advertisement;
presenting to the user within the application the challenge and an input component configured to accept input from the user; and
upon receiving from the user within the input component a challenge response:
comparing the challenge response to the solution, and
upon equating the challenge response and the solution, presenting a reward within the application.
